(19) United States
(12) Patent Application Publication
(10) Pub. No.: US 2018/0149733 A1
(43) Pub. Date: May 31, 2018

(54) METHOD FOR HEATING AN ULTRASONIC TRANSDUCER AND ULTRASONIC TRANSDUCER

(71) Applicant: Robert Bosch GmbH, Stuttgart (DE)

(72) Inventors: Michael Schumann, Stuttgart (DE); Bernd Scherwath, Leonberg (DE); Thomas Treptow, Leonberg (DE)

(73) Assignee: Robert Bosch GmbH, Stuttgart (DE)

(21) Appl. No.: 15/574,707

(22) PCT Filed: Apr. 22, 2016
(86) PCT No.: PCT/EP2016/058956

§ 371 Date: Nov. 16, 2017

(30) Foreign Application Priority Data
Jun. 24, 2015 (DE) 10 2015 211 710.3

(51) Int. Cl. G01S 7/52; G01S 7/521

(52) U.S. Cl. CPC G01S 7/52006; G01S 15/931; G01S 7/521

(57) ABSTRACT

A method for heating an ultrasonic transducer, in which an interior of the ultrasonic transducer together with a diaphragm element is heated by thermal radiation of a component, the temperature of the diaphragm element being increased to a temperature above the freezing point. The heating is achieved by a component which in a first operating mode is used to implement a transmitting and/or receiving operation of the ultrasonic transducer, and in a second operating mode is operated in such a way that the component has an increased electrical power loss compared to the first operating mode.

### FIELD

The present invention relates to a method for heating an ultrasonic transducer. The present invention further relates to an ultrasonic transducer that is capable of being operated according to a method of the present invention.

### BACKGROUND INFORMATION

A ultrasonic transducer is described in German Patent Application No. DE 10 2005 045 019 A1. This ultrasonic transducer is used, usually in conjunction with several ultrasonic transducers situated in the area of a bumper of a motor vehicle, to detect objects that are situated in front of or behind the motor vehicle. Such ultrasonic transducers are in particular part of a driver assistance system, in which for example a driver is supported in a parking process. The proper operation of such ultrasonic transducers presupposes that in particular at temperatures below the freezing point the diaphragm element used to transmit and to receive sonic pulses is free of ice. For this purpose, conventionally, a heating element as an additional component is disposed within the interior of the ultrasonic transducer, by which the interior of the ultrasonic transducer is heated. The thermal radiation of the heating element also heats the diaphragm element so that possibly existing ice is able to melt. The fact that the heating element is an additional component on the one hand increases the required space for the ultrasonic transducer and on the other hand increases the manufacturing costs compared to an ultrasonic transducer that has no such heating elements.

German Patent No. DE 30 13 060 A1 describes operating overhead power lines, as are used for conducting current over long distances, in such away that by shifting a reactive current increased ohmic losses are produced and thus an increased heating of the overhead power line occurs, which melts ice accretion on the overhead power line. Thus, in the latter document, the component (overhead power line) that is at risk of ice accretion is itself heated by an operation at increased ohmic losses.

### SUMMARY

The present invention relates to a method for heating an ultrasonic transducer so as to decrease the expenditure in terms of device engineering for manufacturing the ultrasonic transducer. In particular, sufficient heating is provided for an ultrasonic transducer without requiring additional or separate components for heating the ultrasonic transducer. Furthermore, the present invention provides an ultrasonic transducer that is constructed as compactly as possible by eliminating additional components for heating.

According to an example embodiment of the present invention, this objective may be achieve by a method for heating an ultrasonic transducer by the fact that the heating is achieved by a component which in a first operating mode is used to implement a transmitting and/or receiving operation of the ultrasonic transducer and in a second operating mode is operated in such a way that the component has an increased electrical power loss compared to the first operating the objective is to provide mode.

In other words, according to the present invention, there is no need to provide for the use of additional components that are designed/provided specifically for heating the ultrasonic transducer. Rather, the present invention provides for using those components, which are otherwise, during normal operation (first operating mode), used to transmit and receive ultrasonic signals, in a second operating mode to heat the interior of the ultrasonic transducer. The heating of the interior of the ultrasonic transducer heats the diaphragm element by thermal radiation and thus with sufficient heating also causes a coat of ice possibly adhering to the outside of the diaphragm element to melt. Due to the fact that no additional components are required to heat the interior of the ultrasonic transducer, the method according to the present invention allows for the development of a particularly compact ultrasonic transducer that does not require additional space compared to conventional ultrasonic transducers. Moreover, because the required second operating mode is implemented by controlling the components accordingly, i.e., purely by way of software, the method of the present invention also makes it possible that the manufacturing costs of an ultrasonic transducer according to the present invention are normally not higher compared the related art.

Advantageous developments of the method of the present invention for heating an ultrasonic transducer are described herein.

The basic idea that results in the heating or in the increased electrical power losses of the component is to operate the respective component in a second operating mode at an operating point or in a state in which the component has a lower efficiency factor.

The lower efficiency factor results in the increased power loss required for the radiation of the heat. To achieve such an increased power loss, a first variant of the method according to the present invention provides for the second operating mode to comprise a transmission of transmit pulses of a piezo element that are extended and/or have a higher frequency as compared to the first operating mode. When transmitting transmit pulses of the piezo element that are extended as compared to the first operating mode, it is necessary, however, to observe component-dependent limits, which normally must not exceed a few milliseconds. For this reason, the present invention particularly preferentially provides for operating the transmit pulses in the second operating mode at an increased frequency since this allows the transmit pulses respectively to have a relatively short duration.

The present invention furthermore preferably provides for the second operating mode to comprise a transmission of transmit pulses of a piezo element outside of the resonant frequency of the diaphragm element and/or the piezo element. The background for this is that the efficiency factor of the ultrasonic transformer is lower in the ranges outside of the resonant frequency and that consequently the power that is input is increasingly converted into heat.

It is furthermore noted that said resonant frequency depends on the (ice) coating present on the diaphragm element and also on the ultrasonic transducer or diaphragm element itself. For this reason, it is preferentially provided in further development of the latter provision that a prior impedance measurement is performed on the diaphragm element for determining the frequency for the transmit pulses. For this purpose, frequency ranges having a high impedance are ascertained from the impedance curve (impedance over frequency).

It is moreover particularly advantageous if the second operating mode comprises an operation of a processor core of a microcontroller that results in an increased load on the processor core. The greater load on the processor core results in an increased current consumption in the receiver and thus in an increase of the chip temperature. Such an increased load on the processor core may be achieved for example by a memory-intensive and processing-intensive processing instruction that is started by a special command. It is possible to keep the program code of the processing instruction small if the latter is implemented in a loop. A special operation of an ASIC can also result in an increased component temperature.

Regardless of the manner in which the method of the present invention is implemented concretely or which component is used in the second operating mode to increase the temperature in the interior of the sonic transducer, it is desirable for reasons of the reliability of the sonic transducer to avoid overloading the component. For this reason, another advantageous development of the method provides that the component temperature of at least one component involved in the second operating mode is monitored and that the second operating mode is implemented only below a temperature threshold, the temperature threshold being determined in such a way that damage or predamage of the components operated in the second operating mode is prevented.

Particularly for the case that the temperature is around the freezing point and that with a further drop in temperature there is the risk of ice formation on the diaphragm element of the ultrasonic transducer, there may be a provision for the second operating mode to alternate with the first operating mode. This ensures, on the one hand, the operation of the ultrasonic transducer at least temporarily and on the other hand avoids ice formation on the diaphragm element at falling temperatures.

In order to detect whether the heating of the sonic transducer achieved the desired result or the melting of coatings on the diaphragm element, the present invention furthermore provides for the second operating mode to be controlled as a function of the result of an impedance measurement of the diaphragm element. In other words, the impedance measurement is performed for example at regular intervals and the presence of coatings on the diaphragm element is inferred from the results of the impedance measurement.

The present invention also comprises an ultrasonic transducer having a diaphragm element that is excitable to oscillations by a piezo element as well as electronic components such as a microcontroller having a processor core and a transmission output stage for controlling the piezo element, the electronic components being designed to be operated according to a method of the present invention. Such an ultrasonic transducer has the same advantages as exist in the method according to the present invention described thus far.

A preferred development of an ultrasonic transducer described thus far provides for means for detecting the component temperature of the electronic components in order to avoid damage to the components involved in the second operating mode.

Additional advantages, features and details of the present invention derive from the following description of preferred exemplary embodiments as well as from the figures.

### BRIEF DESCRIPTION OF THE DRAWINGS

FIG. 1 shows a highly simplified longitudinal section through a sonic transducer, which may be operated using a method of the present invention.

FIG. 2 shows a diagram with a representation of the impedance over the frequency.

FIG. 3 shows a block diagram for explaining the operation according to the present invention of the sonic transducer.

### DETAILED DESCRIPTION OF EXAMPLE EMBODIMENTS

Identical elements and elements having the same function are provided with the same reference numerals in the figures.

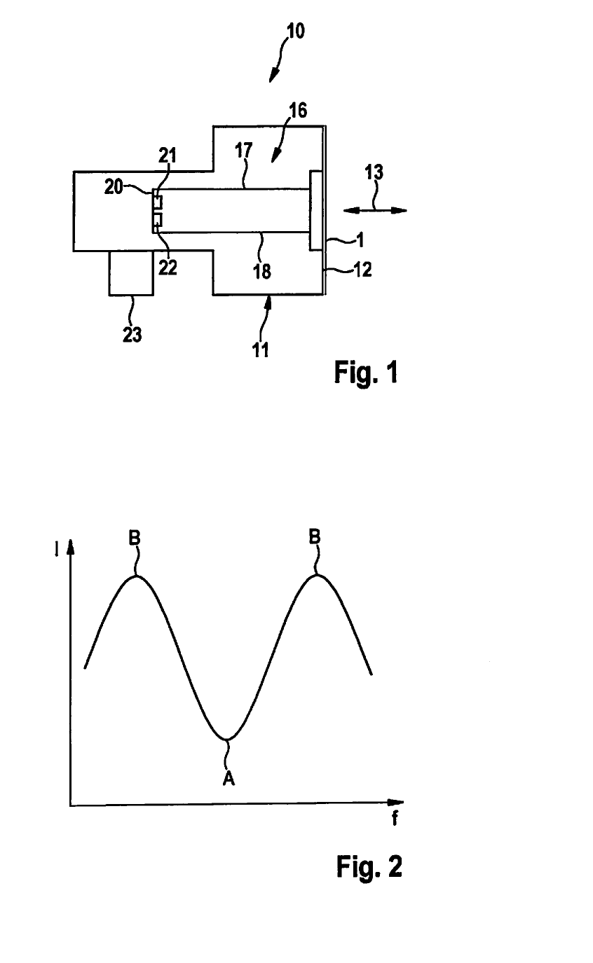

FIG. 1 shows in greatly simplified fashion an ultrasonic transducer 10, as it is used in particular as a component of a driver assistance system in a motor vehicle. For this purpose, usually multiple ultrasonic transducers 10 are installed laterally adjacent to each other in corresponding installation openings of a bumper. Since it is known per se and not essential to the invention, regarding such an installation of an ultrasonic transducer 10 in the bumper of a motor vehicle, reference is made to document DE 10 2005 045 019 A1 of the applicant, which is to that extent to be part of this application.

Ultrasonic transducer 10 has a transducer housing 11 normally made of several components, which forms a diaphragm element 12 in the area of an end face of ultrasonic transducer 10. Transducer housing 10 and in particular diaphragm element 12 are normally made of metal, for example of aluminum, and are produced at least in part by deep drawing. Diaphragm element 12 is developed to transmit and to receive oscillations in the direction of double arrow 13 that runs perpendicularly with respect to the plane of the diaphragm. This operating state represents a first operating mode of ultrasonic transducer 10. The oscillatory ability concerns both the emission of sonic waves in the ultrasonic range as well as the excitation of diaphragm element 12 by sonic waves in the ultrasonic range acting on diaphragm element 12 from outside. The ultrasonic transducer 10 is operated in such a way that by turns sonic pulses are transmitted within a certain time window and subsequently sonic waves are able to be received during a waiting period in order to infer a distance of an object from ultrasonic transducer 10 from the duration between the transmitted and the received sonic waves.

Diaphragm element 12 is disposed in operative connection with a piezo element 15 both in order to produce such oscillations or sonic waves as well as to receive the same. Piezo element 15 is situated in interior 16 of transducer housing 11 and is connected to the side of diaphragm element 12 facing interior 16 preferably via an adhesive connection (not shown). Via electrical connection leads 17, 18, piezo element 15 is connected to a circuit substrate 20, normally in the form of a circuit board. Circuit substrate 20 is also located in interior 16 of transducer housing 11. Electronic components 21, 22 are situated on circuit substrate 20, the electronic components 21, 22 including in exemplary and non-restricting fashion a microcontroller, an ASIC (application-specific integrated circuit component), transmitting and receiving output stages as well as elements for detecting component temperatures such as heat sensors. The ultrasonic transducer 10 described so far is electrically contactable via a plug connector 23.

At temperatures below the freezing point, there is the danger that a coating 1, in particular in the form of icing, forms on the outside of diaphragm element 12 on the side facing away from the interior 16. Such a coating 1 changes the resonant behavior both of diaphragm element 12 as well as of piezo element 15 coupled with diaphragm element 12. To determine whether a coating 1 exists on diaphragm element 12, the present invention provides, in accordance with the representation in FIG. 2, for controlling piezo element 15 with different frequencies f and at the same time to measure the impedance I. The shape of the curve shown in FIG. 2 shows that there exists a relatively low impedance I at point A, while at points B the impedance I exhibits local maxima. Point A indicates the operating point of diaphragm element 12, at which the latter is in resonant frequency. At such a resonant frequency, the energy required for producing oscillations or waves is relatively low. On the other hand, at points B or the corresponding frequencies f, there is a lower efficiency factor due the relatively high impedance. That means that when diaphragm element 12 is controlled by piezo element 15 in the range of frequencies f of points B in a second operating mode the energy is converted with a relatively high component of heat loss. Such an increased heat loss results in a heating of interior 16 of transducer housing 11 and thus also in a melting of coating 1.

It is also possible to effect the increase of the temperature within transducer housing 11 in a second operating mode in that the electronic components 21, 22 are operated in the second operating mode in such a way that increased power losses occur.

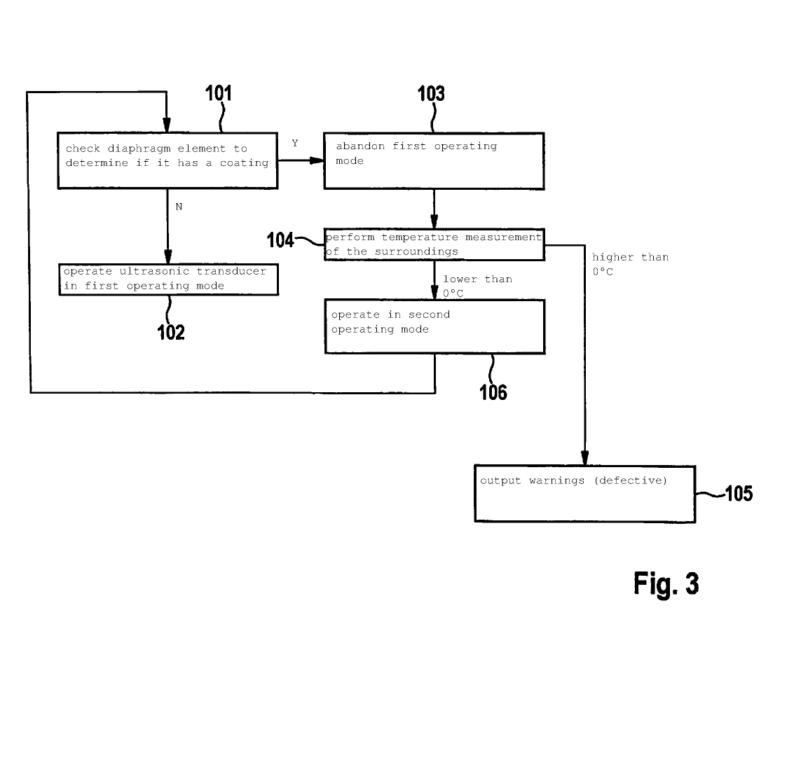

FIG. 3 shows the operating method of the present invention for ultrasonic transducer 10: In a first step 101, diaphragm element 12 is checked to determine if it has a coating 1 using said impedance measurement according to FIG. 2. If the impedance measurement determines that the frequency f, at which the lowest impedance I occurs, is at a frequency f, which typically exists without coatings 1, then an inference is made from this fact that no coating 1 exists on diaphragm element 11. In a second step 102, ultrasonic transducer 10 is operated in the first operating mode that corresponds to the normal measurement operation.

If on the other hand the measurement determines the existence of a coating 1, then, according to step 103, the normal measurement operation, i.e. the first operating mode of ultrasonic transducer 10, is abandoned. Subsequently, a temperature measurement of the surroundings is performed in a step 104, which occurs for example by a temperature sensor that usually exists in a motor vehicle. If the measurement indicates that the temperature is higher than 0° C., then, in accordance with step 105, an inference is made that ultrasonic transducer 10 is defective. This derives from the fact that, in the presence of a temperature of more than 0° C., normally there cannot exist a coating 1. Corresponding warnings may be output to an operator or driver so that the latter is informed about the fact that ultrasonic transducer 10 is not available.

If the temperature of the surroundings is lower than 0° C., on the other hand, then ultrasonic transducer 10 is operated, in accordance with step 106, in the second operating mode, which causes said heating of the interior 16 of transducer housing 11. To verify the efficacy of the measures of the second operating mode, a check is subsequently performed again in accordance with first step 101 for the existence of a coating 1.

The ultrasonic transducer 10 described thus far as well as the operating methods (first and second operating mode) may be adapted or modified in various ways, without deviating from the idea of the present invention. Thus it is possible, for example, to forgo impedance measurements for detecting coatings 1 and to control the operation in the second operating mode solely on the basis of a detected outside temperature. It is then also possible to specify certain frequencies f or different frequencies controlled in succession in order to remove coatings 1 even without impedance measurement.

1-10. (canceled)

11. A method for heating an ultrasonic transducer, in which an interior (16) of the ultrasonic transducer together with a diaphragm element is heated by thermal radiation, the temperature of the diaphragm element being increased to a temperature above the freezing point, the method comprising:
heating the diaphragm by a component, wherein in a first operating mode, the component is used to implement at least one of a transmitting operation and a receiving operation of the ultrasonic component, and in a second operating mode, the component is operated such that the component has an increased electrical loss compared to the first operating mode and heats the diaphragm.

12. The method as recited in claim 11, wherein the second operating mode comprises a transmission of transmit pulses of a piezo element that are one of: (i) extended compared to the first operating mode, and (ii) have a higher frequency as compared to the first mode.

13. The method as recited in claim 11, wherein the second operating mode comprises a transmission of transmit pulses of a piezo element outside of the resonant frequency of at least one of the diaphragm element and the piezo element.

14. The method as recited in claim 13, wherein for determining the frequency of the transmit pulses, an impedance measurement is performed on the diaphragm element.

15. The method as recited in claim 11, wherein the second operating mode comprises an operation of a processor core of a microcontroller that results in an increased load on the processor core.

16. The method as recited in claim 11, wherein a component temperature of at least one component involved in the second operating mode is monitored and the second operating mode is implemented only below a temperature threshold.

17. The method as recited in claim 11, wherein the second operating mode alternates with the first operating mode.

18. The method as recited in claim 11, wherein the second operating mode is controlled as a function of the result of an impedance measurement of the diaphragm element.

19. An ultrasonic transducer, comprising:
a diaphragm element which is excitable to oscillations by a piezo element;
electronic components including a microcontroller having a processor core and a transmission output stage for controlling the piezo element;
wherein the electronic components being designed, in a first operating mode, to implement at least one of a transmitting operation and a receiving operation of the ultrasonic component, and, in a second operating mode, to operate at an increased electrical loss compared to the first operating mode.

20. The ultrasonic transducer as recited in claim 19, further comprising an arrangement for detecting the component temperature of the electronic components.
